(19) United States
(12) Patent Application Publication
(10) Pub. No.: US 2015/0024289 A1
(43) Pub. Date: Jan. 22, 2015

(54) HIERARCHICAL METAL/TiSi2 NANOSTRUCTURE MATERIALS AND METHOD OF PREPARATION THEREOF

(71) Applicant: The Trustees of Boston College, Chestnut Hill, MA (US)

(72) Inventors: Dunwei Wang, Newton Highlands, MA (US); Jin Xie, Brighton, MA (US); Xiaogang Yang, Xuchang (CN); Xiahui Yao, Chestnut Hill, MA (US)

(21) Appl. No.: 14/183,460

(22) Filed: Feb. 18, 2014

Related U.S. Application Data
(60) Provisional application No. 61/766,511, filed on Feb. 19, 2013.

(51) Int. Cl. H01M 4/90; H01M 12/08; H01M 4/92

(52) U.S. Cl. CPC H01M 4/9041; H01M 4/92; H01M 12/08; H01M 4/925
USPC 429/405; 429/523; 429/524; 429/526; 429/525; 502/242

(57) ABSTRACT

The invention provides a unique catalyst system without the need for carbon. Metal nanoparticles were grown onto conductive, two-dimensional material of TiSi₂ nanonet by atomic layer deposition. The growth exhibited a unique selectivity with the elemental metal deposited only on defined surfaces of the nanonets in nanoscale without mask or patterning.

### PRIORITY CLAIMS AND RELATED APPLICATIONS

This application claims the benefit of U.S. Provisional Application No. 61/766,511, filed Feb. 19, 2013, the entire content of which is incorporated herein by reference in its entirety.

### GOVERNMENT RIGHTS

The United States Government has certain rights to the invention pursuant to Grant No. 1055762 from the National Science Foundation to Boston College.

### TECHNICAL FIELDS OF THE INVENTION

The invention generally relates to novel materials comprising a metallic element and TiSi₂ and methods of their preparation. More particularly, the invention relates to novel compositions and hierarchical nanostructures comprising a metallic element (e.g., Pt, Ru, Pd) and TiSi₂, and their gas-phase preparation (e.g., via an atomic layer deposition (ALD) process) and applications in energy storage (e.g., fuel cells, lithium oxygen batteries).

### BACKGROUND OF THE INVENTION

Novel compositions or material morphologies play important roles in diverse technologies and applications such as in the field of electrical energy storage. (Bruce, et al. 2008 Angew. Chem. Int. Ed. 47, 2930-2946; Goodenough, et al. 2010 Chem. Mater. 22, 587-603; Yang, et al. 2012 Nat. Mater. 11, 560-3.) The key challenges encountered in advancing these technologies are often associated with material designs, particularly on the nanoscale. Single component nanostructures, for example, experience inherent limitations as they face diverse functional needs in more and more complex systems. While heteronanostructures show great promise by delivering multiple functionalities simultaneously, they encounter various challenges in terms of preparation, for example, the lack of precise control of deposition sites at small dimension but large scale. As a result, a wider use of fine hierarchical nanostructures has been hampered by high cost of equipment and process complexity (e.g., advanced soft lithography and precise surface treatment).

For instance, electrode design for proton exchange membrane fuel cells is one such area where such issues are critical. (Markovic, et al. 2001 Fuel Cells 1, 105-116; Gasteiger, et al. 2005 Appl. Catal. B 56, 9-35; Stamenkovic, et al. 2007 Science 315, 493-497; Gasteiger, et al. 2009 Science 324, 48-49; Stephens, et al. 2011 J. Am. Chem. Soc. 133, 5485-5491.) To afford high current density, conductive frameworks with high surface area are desired for the electrode's construction. Porous carbon, especially those with nanoscale pores, is popularly used as a scaffold, onto which catalysts for oxygen reduction reaction (ORR) and/or hydrogen oxidation reaction (HOR) are dispersed. The choice of porous carbon could limit the performance of fuel cells, including poor stability and reduced catalytic activities. Another example is in lithium oxygen batteries where carbon support electrodes have been discovered as a main failing mechanism due to its instability during operation. (Wang, et al. 2007 J. Power Sources 171, 331-339; Adzic, et al. 2007 Top. Catal. 46, 249-262; Stamenkovic, et al. 2007 Nat. Mater. 6, 241-247; Strasser, et al. 2010 Nat. Chem. 2, 454-460.) To date, examples of low-cost, non-carbon-based porous conductive frameworks remain rare other than those involving precious metals. (Ding, et al. 2004 Adv. Mater. 16, 1897-1900; Peng, et al. 2012 Science 337, 563-566.)

Thus, it remains critically important to develop conductive, porous materials that are inexpensive and carbon free. Such materials have the potential to enable significant advances in diverse fields such as in electrical energy storage.

### SUMMARY OF THE INVENTION

The invention provides novel materials and compositions achieved from a highly selective growth of a metallic element (e.g., a transition metal such as Pt, Pd and Ru) on the b planes of TiSi₂ nanonets by atomic layer deposition. In the case of Pt, as-grown Pt nanoparticles exhibit an unusual 5-fold twinned structure that preferably exposes {111} surfaces of Pt. The resulting material showed high activity toward ORR reactions and great potentials as a promising air cathode for applications like fuel cells. Similarly, another composition, Ru/TiSi2, showed promising performance as air cathode for lithium oxygen batteries. The open structures allow high current densities, a highly coveted feature for applications such as electric transportation.

For many electrochemical reactions such as oxygen reduction, catalyst supports are of critical importance as they provide large surface area for catalyst loading and pathways for electron and mass transfer. Presently, porous carbon is the most commonly employed, the application of which has been recently recognized to be a potential source of concerns.

The invention provides a conductive, two-dimensional material of the TiSi₂ nanonet, a unique supporting material to replace carbon. Metal nanoparticles were grown onto TiSi₂ by atomic layer deposition. Surprisingly, the growth exhibited a unique selectivity, for example, with Pt deposited only on the top/bottom surfaces of the nanonets in nanoscale without mask or patterning. The materials showed great promise in catalyzing oxygen reduction reactions as one of the key challenges in both fuel cells and metal air batteries.

In one aspect, the invention generally relates to a catalytic system. The catalytic system includes nanoparticles of a metallic element grown onto one or more two-dimensional conductive nanostructures of TiSi₂, wherein the catalyst system does not comprise carbon.

In another aspect, the invention generally relates to nanoparticles of a metallic element grown on a surface of a two-dimensional conductive nanostructure of TiSi₂.

In yet another aspect, the invention generally relates to catalytic system comprising the nanoparticles according to the invention.

In yet another aspect, the invention generally relates to a fuel cell comprising a catalytic system according to the invention.

In yet another aspect, the invention generally relates to a battery comprising a catalytic system according to the invention.

In yet another aspect, the invention generally relates to a method for growing a metallic element on a surface of substrate. The method includes: providing one or more precursors of a metallic element; providing TiSi₂ having one or more conductive nanostructures (e.g., two-dimensional nanonets); generating the metallic element in the gaseous phase; and depositing the metallic element on the two-dimensional conductive nanostructures of TiSi₂. The metallic element exhibits a pre-select crystalline surface.

### BRIEF DESCRIPTION OF THE FIGURES

FIG. 1. Schematics of Pt nanoparticles deposition on different TiSi₂ nanostructures. (a) Selective deposition is achieved on the layered C49 TiSi₂, whose b planes consist of alternate layers of Ti—Si mixture and Si-only atoms. Because the unit cell of C49 TiSi₂ is highly anisotropic (with b lattice nearly four times of a and c), its bulk form was known as metastable, and the only stable C49 TiSi₂ was found in the nanonet morphology. (Zhou, et al. 2008 Angew. Chem. Int. Ed. 47, 7681-7684; Zhou, et al. 2009 Chem. Mater. 21, 1023-1027.) Pt nanoparticles grow on the top and bottom surfaces that are the b planes terminated by Si. For clarity, only one beam is shown here. (b) Pt nanoparticles grow non-selectively on all surfaces on C54 TiSi₂ nanowires that are identical in compositions and similar in sizes to the nanonets. The main difference of C54 TiSi₂ from the C49 one is the lack of Si-only layers on its surface and, hence, the lack of layered, anisotropic structures.

FIG. 2. Microstructures of Pt/TiSi₂ heteronanostructures by a typical 50-cycle ALD growth. (a) When viewed from the top, uniform distribution of Pt nanoparticles are observed. (b) When viewed from the side, Pt nanoparticles are only seen on the top and bottom surfaces of TiSi₂. The relationship is schematically illustrated in the insets. (c) The sizes distribution of Pt nanoparticles.

FIG. 3. Transmission electron micrographs of Pt nanoparticles on various substrates by ALD method. (a) and (b): C54 TiSi₂ nanowires; (c) and (d): TiO₂-coated C49 TiSi₂ nanonets; (e) and (f): Si nanowires.

FIG. 4. (a) Dependence of Pt nanoparticle sizes and mass loading (relative to the total mass of Pt and TiSi₂ nanonet support) on ALD cycle numbers. (b), (c) and (d) Histogram of Pt nanoparticle diameters for 30, 70 and 100 ALD cycles of Pt deposition on TiSi₂ nanonets, respectively.

FIG. 5. Representative high magnification TEM images of multiple-twinned Pt nanoparticles deposited on TiSi₂ by ALD. (a) An unusual 5-fold twinning effect is observed in the high resolution TEM image with zone axis <110>. (b)-(d) showed high yield of multiple-twinned Pt nanoparticles.

FIG. 6. ORR catalytic activities of Pt/TiSi₂ and Pt/C in 0.1 M KOH electrolyte. (a) Polarization curves of Pt/TiSi₂ at a scan rate of 10 mV s⁻¹ at varying rotation rates (b) Polarization curves of Pt/C at a scan rate of 10 mV s⁻¹ at various rotation rates (c) The resulting Pt/TiSi₂ heteronanostructures exhibit different cyclic voltammetry characteristics (red trace) from that of commercial Pt/C catalyst (black trace) when measured in O₂-free environments. (d) Tafel plots of the specific ORR activity Pt/TiSi₂ and Pt/C based on (1/i=1/iₖ+1/i_{D}) at a rotation rate of 1600 rpm and a scan rate of 10 mV s⁻¹.

FIG. 7. Structures of Pt/TiSi₂ heteronanostructures prepared on Ti mesh and their catalytic activities. (a-c) Low, medium, and high magnification SEM images of Pt/TiSi₂ grown on Ti mesh. Inset in (c): a 50000-time magnified view to reveal the two-dimensional nature of the nanonet morphology. (d) Polarization curve for ORR of Pt/TiSi₂ on mesh in 0.1 M KOH at a scan rate of 20 mV s⁻¹ at 25° C. As a comparison, the performances of Pt on Ti mesh in the absence of TiSi₂ nanonets (blue trace) and Pt/TiSi₂ on Ti foil (black trace) are shown. The Pt loading on Ti foil and Ti mesh sample are 50 μg_{Pt} cm_{geo}⁻² and 99 μg_{Pt} cm_{geo}⁻², respectively.

FIG. 8. (a) CVs of Pt/TiSi₂ sample (red) and Pt/C sample (black) in 0.1 M KOH at 25° C.; (b) CVs of Pt low-index single-crystal surfaces (Pt (111), Pt (100) and Pt (110)) in 0.1 M KOH. Adapted from Markovic et al., J. Chem. Soc., Faraday Trans., 1996.

FIG. 9. Microstructures of Ru/TiSi₂ heteronanostructures. (a) When viewed from the top, a uniform distribution of Ru nanoparticles is observed. (b) When viewed from the side, Ru nanoparticles are seen only on the top and bottom surfaces of TiSi₂.

FIG. 10. Cycle performance of Ru/TiSi₂ cathode. (a) Ru/TiSi₂ showed improved capacity and reduced overpotential compared to bare TiSi₂. (b) and (c) Ru/TiSi₂ cycled for 60 cycles with limited performance drop.

FIG. 11. Structures of Ru/TiSi₂ before and after cycle test. (a) As prepared Ru/TiSi₂. (b) Ru/TiSi₂ after 1^{st} discharge cycle; (c) Ru/TiSi₂ after 60 cycles, fully charged.

### DESCRIPTION OF THE INVENTION

This invention provides a unique class of materials comprising a metallic element, such as a transition metal, and TiSi₂ and methods of their preparation. More particularly, the invention relates to novel compositions of hierarchical nanostructures comprising a metallic element and TiSi₂, and their gas-phase preparation (e.g., via an ALD process). The invention employs a novel gas-phase ALD technique for heteronanostructure fabrication on anisotropic substrates with site selectivity. The invention offers a much-needed methodology for site selective deposition, which is superior to the traditional expensive and complex photolithography techniques. Such heteronanostructure may find wide applications in energy storage and energy conversions.

The effective surface energy control allows site selective deposition. By using the anisotropic surfaces of a substrate, the invention does not rely on patterning. Furthermore, the rich chemistries of atomic layer deposition facilitate the control of various functional materials to be deposited on different types of substrates even with high aspect ratio.

For example, inexpensive and easy to prepare TiSi₂ nanonets are employed. (Zhou, et al. 2008 Angew. Chem. Int. Ed. 47, 7681-7684; Zhou, et al. 2009 Chem. Mater. 21, 1023-1027; Zhou, et al. 2011 ACS Nano 5, 4205-4210.) When used to grow Pt, a highly unusual selective deposition is obtained, resulting in 5-fold twinned Pt nanoparticles whose {111} planes are preferably exposed. The Pt/TiSi₂ combination exhibits ORR activities in aqueous solutions comparable to that of optimized commercial Pt/C catalyst, establishing the nanonet as a promising candidate for air electrode design and construction.

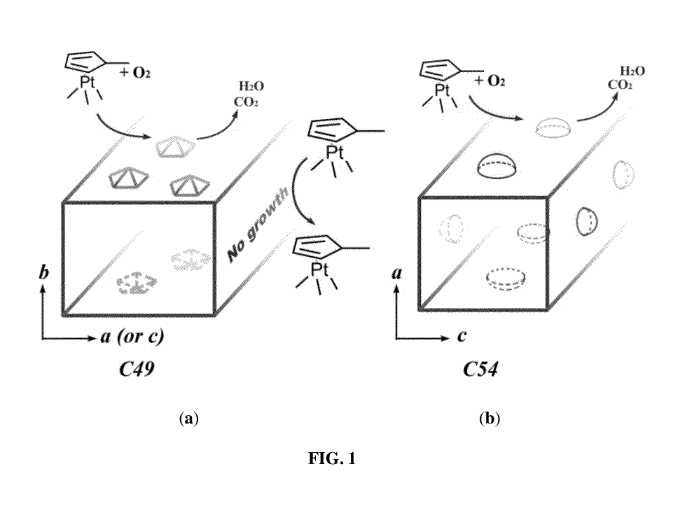

FIG. 1 shows schematics of Pt nanoparticles deposition on different TiSi₂ nanostructures. Selective deposition (FIG. 1a) is achieved on the layered C49 TiSi₂, whose b planes consist of alternate layers of Ti—Si mixture and Si-only atoms. Because the unit cell of C49 TiSi₂ is highly anisotropic (with b lattice nearly four times of a and c), its bulk form was known as metastable, and the only stable C49 TiSi₂ was found in the nanonet morphology. (Zhou, et al. 2008 Angew. Chem. Int. Ed. 47, 7681-7684; Zhou, et al. 2009 Chem. Mater. 21, 1023-1027.) Pt nanoparticles grow on the top and bottom surfaces that are the b planes terminated by Si. As shown in FIG. b, Pt nanoparticles grow non-selectively on all surfaces on C54 TiSi₂ nanowires that are identical in compositions and similar in sizes to the nanonets. The main difference of C54 TiSi₂ from the C49 one is the lack of Si-only layers on its surface and, hence, the lack of layered, anisotropic structures.

The invention provides unconventional heterostructure functional materials and a novel approach to material fabrication via ALD. First, the invention offers a unique combination of Pt and TiSi₂. TiSi₂ (titanium silicide) has a high surface area and high conductivity, a perfect candidate as a scaffold for electrocatalysts. Pt (Platinum) is one of the most widely used catalysts in diverse industrial applications. The combination of Pt/TiSi₂ as disclosed herein has a potential to replace currently used Pt/C (carbon) catalyst. Second, the invention employs an improved ALD process that not only provides conformal deposition, but also selective deposition. In certain embodiments, ALD precursors are selectively adsorbed and decomposed on certain crystal faces with crystal growth taking place at the reactive sites in a layer-by-layer growth fashion. This technique exhibits advantages in high efficient deposition, precise site control cost effective and capability of coating on complex nanostructures with high aspect ratios.

An exemplary application of the hierarchical nanostructures of Pt/TiSi₂ is for use as an electrocatalyst for fuel cells. The deposition of Pt particles showed a high concentration of twinning and {111} surface termination. As a result, the Pt/TiSi₂ of the invention has an improved specific activity and mass activity compared to the traditional Pt/C catalyst for oxygen reduction reaction in aqueous media.

The invention offers various advantages over existing technologies. For example, the selective gas-phase deposition of functional materials on TiSi₂ does not require complex photolithography or electron beam lithography processes. The site selective deposition originates from the anisotropic surface of TiSi₂ nanostructures. Thus, the selective deposition process of the invention offers cost benefits in production and is also amenable to large-scale production. The selective deposition also offers precision control superior over many lithography techniques and can reach down to nm range (e.g., 20 nm). In addition, the materials prepared by gas-phase synthesis may avoid serious contaminations or ligand passivation common in liquid phase synthesis.

In one aspect, the invention generally relates to a catalytic system. The catalytic system includes nanoparticles of a metallic element grown onto one or more conductive nanostructures (e.g., two-dimensional nanonets) of TiSi₂, wherein the catalyst system does not comprise carbon.

In another aspect, the invention generally relates to nanoparticles of a metallic element grown on a surface of a two-dimensional conductive nanostructure of TiSi₂.

The metallic element may be any suitable metallic element, for example, a transition metal element such as Pt, Ru, Pd

In certain preferred embodiments, the nanoparticles of a metallic element are grown onto the one or more two-dimensional conductive nanostructures of TiSi₂ by atomic layer deposition.

In certain preferred embodiments, the nanoparticles of a metallic element are grown onto the one or more two-dimensional conductive nanostructures of TiSi₂ without mask or patterning.

In certain preferred embodiments, the nanoparticles of a metallic element are selectively grown only on the top and/or bottom surfaces of the one or more two-dimensional conductive nanostructures of TiSi₂.

In certain preferred embodiments, the nanoparticles of a metallic element are crystalline.

In certain preferred embodiments, the nanostructures of TiSi₂ are selected from nanonets and nanowires of TiSi₂.

In certain preferred embodiments, the nanonets of TiSi₂ have dimensions from about 0.1 μm to about 50 μm (e.g., from about 0.5 μm to about 25 μm, from about 1.0 μm to about 10 μm).

In certain preferred embodiments, the metallic element is Pt and the nanoparticles selectively exhibit a 5-fold twinned structure exposing {111} surfaces of Pt.

In certain preferred embodiments, the nanoparticles are selectively grown on one or more (020) planes of TiSi₂ nanonets.

In yet another aspect, the invention generally relates to a method for growing a metallic element on a surface of substrate. The method includes: providing one or more (e.g., 1, 2, 3) precursors of a metallic element; providing TiSi₂ having one or more two-dimensional conductive nanostructures; generating the metallic element in the gaseous phase; and depositing the metallic element on the two-dimensional conductive nanostructures of TiSi₂. The metallic element exhibits a pre-select crystalline surface.

The one or more precursors may be selected from organometallic compounds. For example, Pt may be generated from precursors such as Trimethyl(methylcyclopentadienyl)platinum(IV) (MeCpPtMe₃). Ru may be generated from precursors such as Bis(ethylcyclopentadienyl)ruthenium(II) (Ru(EtCp)₂). Pd may be generated from precursors such as Palladium(II) hexafluoroacetylacetonate (Pd(hfac)₂).

In yet another aspect, the invention generally relates to catalytic system comprising the nanoparticles according to the invention.

In yet another aspect, the invention generally relates to a fuel cell comprising a catalytic system according to the invention.

In yet another aspect, the invention generally relates to a battery comprising a catalytic system according to the invention.

### EXAMPLES

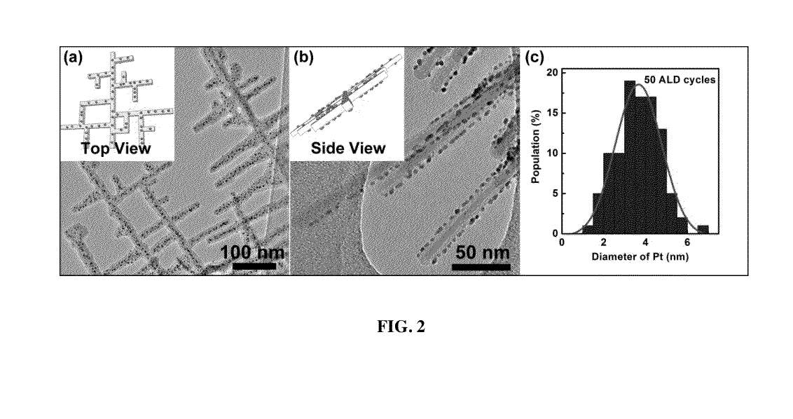

Performance of the Pt/TiSi₂ nanonet combination was compared with Pt/C-based system. (Zhou, et al. 2011 Chem. Soc. Rev. 40, 4167-4185; Bing, et al. 2010 Chem. Soc. Rev. 39, 2184-2202.) To obtain uniform coverage of Pt nanoparticles on the surface of TiSi₂ nanonets, which is important for electrochemical ORR reactions, atomic layer deposition was adopted as the preparation method. (Christensen, et al. 2009 Small 5, 750-757.) A highly selective deposition was obtained, with Pt nanoparticles only growing on the (020) planes of TiSi₂ nanonets (FIG. 1). Transmission electron micrographs (TEM) of top- and side-views (FIGS. 2a and 2b, respectively) confirmed that the deposition was indeed only on the top and bottom, but not on the side surfaces of TiSi₂ nanonets. For a total of more than 200 samples out of 30 batches of growths studied, all of them exhibited the same selectivity, thereby ruling out that the observation was a phenomenological effect.

Although selective growth of nanoparticles such as Ag and Pt on the tips of ZnO and CdS nanorods, respectively, have been reported, similar selectivity of gas-phase deposited nanoparticles on a nanostructured substrate is not known. (Pacholski, et al. 2004 Angew. Chem. Int. Ed. 43, 4774-4777; Habas, et al. 2008 J. Am. Chem. Soc. 130, 3294-3295; Amirav, et al. 2010 J. Phys. Chem. Lett. 1, 1051-1054.)

FIG. 2 shows microstructures of Pt/TiSi₂ heteronanostructures by a typical 50-cycle ALD growth. As depicted in FIG. 2a, when viewed from the top, uniform distribution of Pt nanoparticles are observed. When viewed from the side (FIG. 2b), Pt nanoparticles are only seen on the top and bottom surfaces of TiSi₂. The inserts schematically illustrate such relationship. The size distributions of Pt nanoparticles are shown in FIG. 2c.

Regarding the nanonet form of TiSi₂, it is of a layered structure known as C49 and different from its bulk and nanowire counterparts (C54). The top and bottom surfaces of TiSi₂ nanonets are the b planes which are made of Si atoms only. (Zhou, et al. 2008 Angew. Chem. Int. Ed. 47, 7681-7684.)

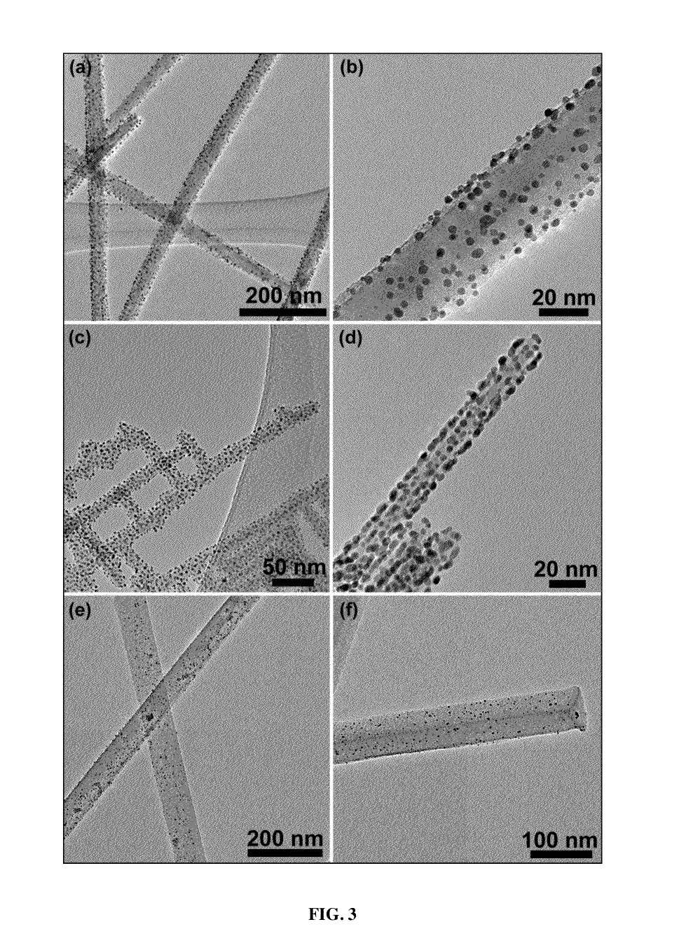

A number of control experiments were carried out to demonstrate that the growth is indeed specific to TiSi₂ nanonets. FIG. 3 shows transmission electron micrographs of Pt nanoparticles on various substrates by ALD method ((a) and (b) were from C54 TiSi₂ nanowires; (c) and (d) were from TiO₂-coated C49 TiSi₂ nanonets; and (e) and (f) were from Si nanowires.

First, Pt deposition on TiSi₂ nanowires was studied. As schematically shown in FIG. 1b, and in FIGS. 3a and 3b, Pt nanoparticles of sizes comparable to those grown on TiSi₂ nanonets were obtained without obvious selectivity in their deposition sites. This means that Pt nanoparticles were evenly distributed on all surfaces of TiSi₂ nanowires. Given that TiSi₂ nanowires are of similar sizes and identical chemical compositions to TiSi₂ nanonets, it is understood that the small sizes (ca. ˜20 nm in diameters) and chemical compositions (TiSi₂) are not the causes for the selective deposition.

To understand whether the nanonet morphology played a role in the selective deposition, a thin layer (10 ALD cycles) of TiO₂ was grown by ALD on TiSi₂ nanonets, converting the surfaces (top, bottom and sides) to a non-distinguishable TiO₂ coverage. (Lin, et al. 2009 J. Am. Chem. Soc. 131, 2772-2773.) Subsequent ALD growth resulted in a uniform deposition of Pt nanoparticles (FIGS. 3c and 3d). This result indicates that morphology alone is not the reason for the selective growth.

Taken as a whole, the results establish that the selective deposition of Pt nanoparticles was specific to TiSi₂ nanonets, and the surfaces are the key reason for the selectivity. It is worth noting that TiSi₂ nanonets exhibit a resistivity of ca. ˜10 ˜Ωcm, which is approximately 10 times better than bulk C49 TiSi₂ and comparable to the more conductive C54. Previous studies suggest that the improved conductivity is due to the lack of stacking faults along the b direction in the nanonets. (Zhou, et al. 2008 Angew. Chem. Int. Ed. 47, 7681-7684.)

The surface energy difference is believed to be an important factor that governs the selective growth. The selective deposition disclosed herein is highly reproducible. (Lin, et al. 2009 J. Am. Chem. Soc. 131, 2772-2773; Liu, et al. 2011 Angew. Chem. Int. Ed. 50, 499-502; Lin, et al. 2011 J. Am. Chem. Soc. 133, 2398-2401.) For C49 TiSi₂, theoretical studies show that b planes are more stable than a and c planes by up to 20% in surface energies; the difference between various planes of C54 TiSi₂ is much less pronounced. (Wang, et al. 2006 Appl. Surf Sci. 252, 4943-4950.)

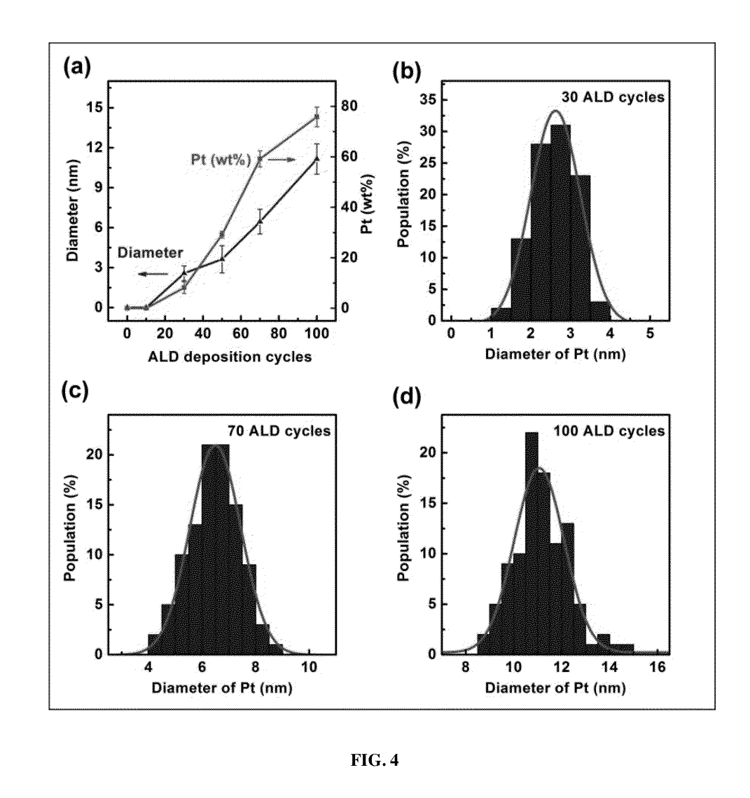

FIG. 4a shows dependence of Pt nanoparticle sizes and mass loading (relative to the total mass of Pt and TiSi₂ nanonet support) on ALD cycle numbers. FIGS. 4b, 4c and 4d show histogram of Pt nanoparticle diameters for 30, 70 and 100 ALD cycles of Pt deposition on TiSi₂ nanonets, respectively. The size of Pt nanoparticles and their mass loading density were found to depend on the ALD cycles following a pseudo-linear relation (FIGS. 4 and 2c). There was an induction time (ca. 10 cycles) for Pt deposition with an island nucleation on the TiSi₂ nanonets substrate. The sizes and mass loading of Pt increased with increasing ALD Pt cycle numbers. For 30, 50, 70, 100 cycles of ALD Pt deposition, the mean particle sizes were 2.6±0.6 nm, 3.6±1.0 nm, 6.4±0.9 nm, and 11.2±1.1 nm, respectively. And their mass loadings as determined by EDS were 8.2±2.3%, 29.2±1.3%, 59.2±3.2%, and 75.8±3.9%, respectively. The quantification of Pt loading was confirmed by ICP-OES (Perkin Elmer optima 3000 x1 ICP-OES spectrometer) measurements.

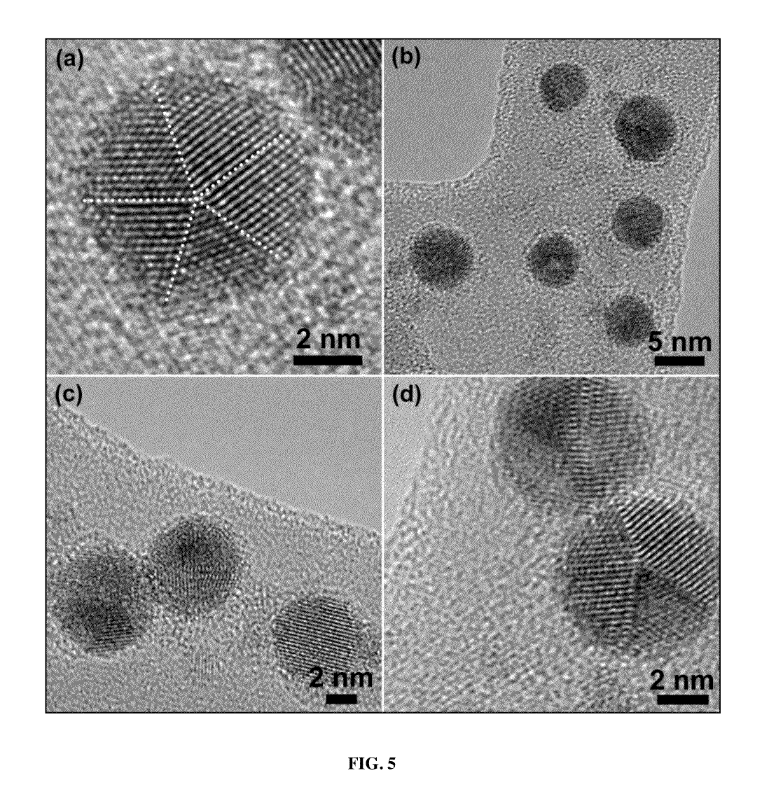

The resulting Pt nanoparticles are crystalline in nature. Representative high magnification TEM images of multiple-twinned Pt nanoparticles deposited on TiSi₂ by ALD are shown in FIG. 5. FIG. 5a shows an unusual 5-fold twinning effect is observed in the high resolution TEM image with zone axis <110>. FIG. 5b-5d depict high yield of multiple-twinned Pt nanoparticles. Significantly, high-resolution TEM (HRTEM) studies revealed that more than 90% of the Pt nanoparticles grown on TiSi₂ nanonets exhibited a multi-twinned structure. A representative example was with zone axis <110> (FIG. 5a). The angles between the twin planes range from 70˜74°, in close resemblance to other 5-fold twinned metal nanoparticles such as Ag and Au. (Sun, et al. 2012 Nat. Commun. 3, 971; Sanchez-Iglesias, et al. 2006 Adv. Mater. 18, 2529-2534.) Because such twinning effect exposes Pt {111} surfaces, which are believed to be catalytically more active, research efforts have been attracted to emulate the effect by, for example, growing Pt epitaxial overlayer on multiple-twinned nanoparticle cores or alloying with Pd. (Yang, et al. 2012 ACS Nano 6, 9373-9382; Xia, et al. 2009 Angew. Chem. Int. Ed. 48, 60-103.) High yield of pure Pt nanoparticles that are 5-fold twinned have not been achieved prior to disclosure herein.

The nanonet-substrate was of critical importance to the high yield of the twinned Pt nanoparticles. When the nanonet was replaced by TiSi₂ nanowires or TiO₂-coated nanonets, the yield of twinned Pt nanoparticles dropped dramatically to <5%, although the total number of particles deposited remained comparable. It is believed that the interaction between Pt and the TiSi₂ nanonet b planes plays a key role to the formation of twinned Pt nanoparticles.

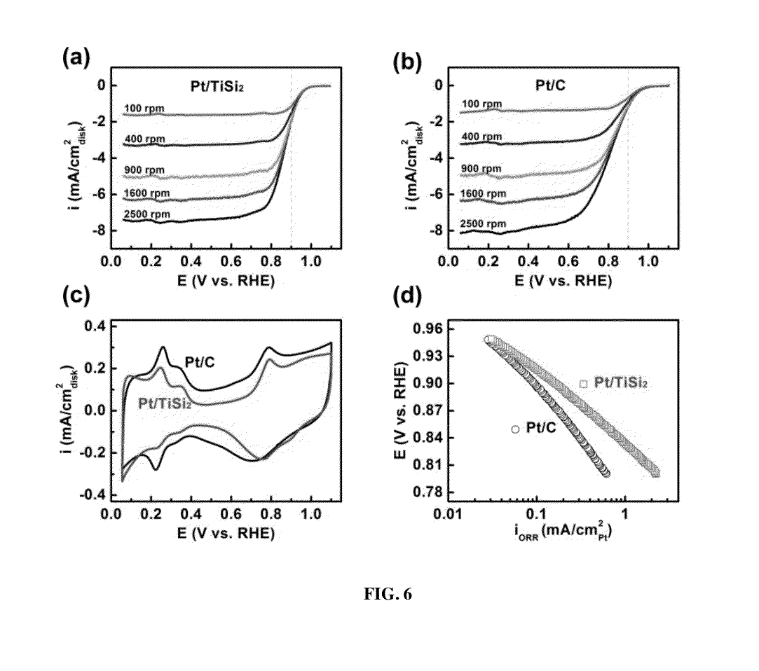

Catalytic activity for ORR in aqueous solution was studies. FIG. 6 shows exemplary data on ORR catalytic activities of Pt/TiSi₂ and Pt/C in 0.1 M KOH electrolyte. For comparison, electrodes of both Pt/TiSi₂ heteronanostructures and commercially obtained Pt/C (46 wt % supported by Vulcan carbon, Tanaka Kikinzoku) were shown in FIGS. 6a and 6b, respectively. FIG. 6a depicts polarization curves of Pt/TiSi₂ at a scan rate of 10 mV s⁻¹ at varying rotation rates. FIG. 6b shows polarization curves of Pt/C at a scan rate of 10 mV s⁻¹ at various rotation rates. Since the average diameter of Pt nanoparticles in the Pt/C catalyst was ˜3.5 nm measured from TEM images (3-4 nm provided by vendor), we chose to test Pt nanoparticles of similar sizes, which were produced by a 50-cycle ALD growth. When TiSi₂ on Ti foil was used as a substrate, an areal density of 50 μg_{Pt} cm_{disk}⁻² was obtained. The loading density can be readily improved.

As shown in FIG. 6c, FIG. 6d provide Tafel plots of the specific ORR activity Pt/TiSi₂ and Pt/C based on (1/i=1/iₖ+1/i_{D}) at a rotation rate of 1600 rpm and a scan rate of 10 mV s⁻¹ .

Cyclic voltammetry (CV) of both TiSi₂/Pt and Pt/C was first obtained in 0.1 M KOH at 25° C., and the purpose was to measure their electrochemically active surface area (ESA). The data was collected in alkaline solutions because our later characterizations were performed in solutions of the same conditions. As shown in FIG. 6c, the resulting Pt/TiSi₂ heteronanostructures exhibit different cyclic voltammetry characteristics (red trace) from that of commercial Pt/C catalyst (black trace) when measured in O₂-free environments. Pt/TiSi₂ heteronanostructures showed CV features characteristic of Pt (111) surfaces, which is in excellent agreement with HRTEM characterizations.

By comparison, the CV features of Pt/C were consistent with those of Pt (110) and (100) surfaces. A Pt ESA of 27.9 m² g⁻¹ was obtained on Pt/C while Pt/TiSi₂ exhibited a slightly higher value of 35.1 m² g⁻¹. Note that the areal densities in terms of Pt mass loading for both were comparable (ca. 50 μg_{Pt} cm_{disk}⁻²). As such, the ESA difference is significant. One cause contributing to this difference may come from the multiple-twinned nature of Pt in Pt/TiSi₂, which exposes more (111) surface atoms. (Yang, et al. 2012 ACS Nano 6, 9373-9382.) Another reason may be found in the relatively simple interface between Pt/TiSi₂, which ensures more Pt exposure; by comparison, in Pt/C mixture, carbon may wrap around Pt to reduce the effective surface areas.

To study the ORR catalytic activity, measurements were carried out in O₂ saturated alkaline solution (0.1 M KOH, 25° C.) by the rotating disk electrode (RDE) technique. ORR polarization curves of both Pt/TiSi₂ and Pt/C at all rotating rates showed a diffusion- or mass-transfer-controlled region at voltages below 0.6-0.7 V vs. RHE (reversible hydrogen electrode), and diffusion-kinetic combined region above 0.7-0.8 V vs. RHE. The limiting currents at diffusion-controlled region are well defined as the current densities increase with ω^{1/2}. As shown in FIGS. 6a and 6b, the polarization curves of Pt/TiSi₂ showed slight anodic shifts and more steep slopes than those of Pt/C, which indicated a better catalytic activity. The true kinetic current densities showed in FIG. 6d were calculated according to the Koutecky-Levich equation (see supporting information). A non-optimized Pt/TiSi₂ combination already exhibited superior performance when compared with the optimized commercial Pt/C. At 0.9 V vs. RHE, the corrected kinetic current density of Pt/TiSi₂ heteronanostructure was 160 μA cm²_{Pt}, which is considerably higher than 90 μA cm²_{Pt} of Pt/C, indicating much higher ORR activity for the selectively grown Pt on TiSi₂ nanonets.

The 5-fold twinned nature of the Pt nanoparticles is an important reason for the performance difference. It was also noticed that Pt/TiSi₂ and Pt/C samples had slightly different slopes of 80.2 mV/decade and 110.9 mV/decade, respectively, which is in agreement with literature reports of pure Pt (111) and Pt (100) surfaces in 0.1 M KOH. (Ross, P. N., Oxygen Reduction Reaction on Smooth Single Crystal Electrodes. In Handbook of Fuel Cells, John Wiley & Sons, Ltd: 2010.)

To optimize the properties of Pt/TiSi₂ for further improvement of the catalytic activities as shown in FIG. 6, it was envisioned that the charge transfer kinetics may be increased by further optimizing the ALD process. In addition, if the gas diffusion is improved, the saturation current is envisioned to increase, as well. To reduce the limitation of mass transfer, a set of experiments were carried out on porous supporting charge collectors of Ti mesh. Since TiSi₂ nanonets can be synthesized on a variety of different substrates, this idea was readily tested. (Zhou, et al. 2011 ACS Nano 5, 4205-4210.) As a proof-of-concept, it was chosen to grow TiSi₂ nanonets on Ti mesh (wire diameter: 250 μm; pore size: 200 μm; Cleveland Wire Cloth), followed by ALD deposition of Pt nanoparticles.

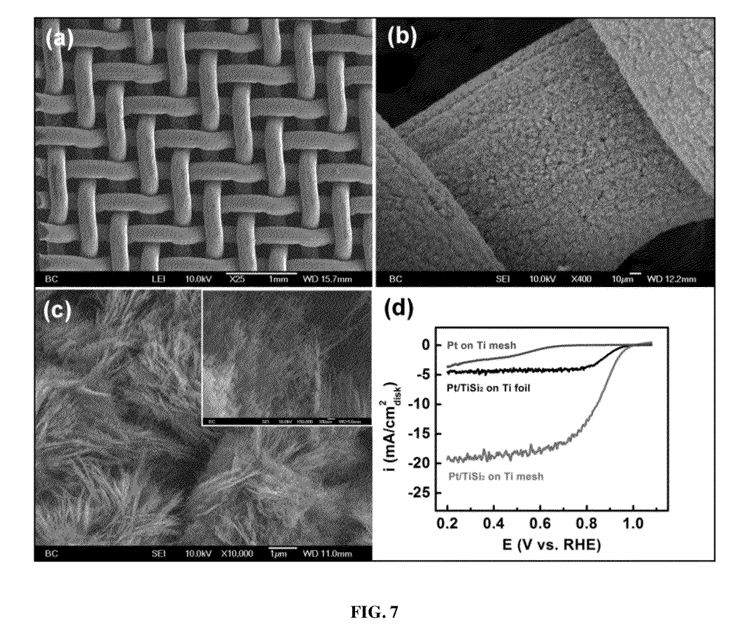

FIG. 7 shows structures of Pt/TiSi₂ heteronanostructures prepared on Ti mesh and their catalytic activities (low, medium, and high magnification SEM images of Pt/TiSi₂ grown on Ti mesh). Structural studies by scanning electron microscopy (SEM) revealed that TiSi₂ nanonets grew uniformly on Ti mesh (FIG. 7a), including the junction areas of the inter-woven wires (FIG. 7b). Higher magnification scanning electron micrograph as shown in FIG. 7c confirmed that TiSi₂ nanonets were of high density and purity. A significant advantage of the TiSi₂ nanonet synthesis is that the growth does not require growth catalysts, which greatly simplifies the electrode fabrication process and avoids producing unnecessary impurities to undermine the catalytic activities.

A saturation current density of 19.3 mA cm_{geo}⁻² was measured (FIG. 7d), which represents an almost 3-fold increase as compared with TiSi₂ on planar Ti foil. Note that the Pt loading per unit geometric area only increased from 50 to 99 μg_{Pt} cm_{geo}⁻², corresponding to an increase of only 1-fold. Greater current density Ti mesh samples resulted from better O₂ diffusion but not from a simple increase of Pt loading. In general, the saturation current density in an ORR reaction is limited by three factors: the resistance in charge transfer, the resistance in charge transport, and the limitation of mass transport. Because the nature of Pt nanoparticles grown on TiSi₂/Ti mesh is identical to that of Pt nanoparticles prepared on TiSi₂/Ti foil, the differences in charge transfer and transport are expected to be negligible. As such, the change in mass transfer is the most plausible reason to explain the observed enhancement of saturation current densities. Similar results have been observed on traditional carbon paper when acting as a gas diffusion layer to enhance the mass transfer of O₂. (Ross, P. N., Oxygen Reduction Reaction on Smooth Single Crystal Electrodes. In Handbook of Fuel Cells, John Wiley & Sons, Ltd: 2010.) In addition, metal foams and meshes have been applied as Pt supports as well, especially in the case of direct methanol fuel cells. (Liang, et al. 2011 Nat. Mater. 10, 780-786; Arisetty, et al. 2007 J. Power Sources 165, 49-57.)

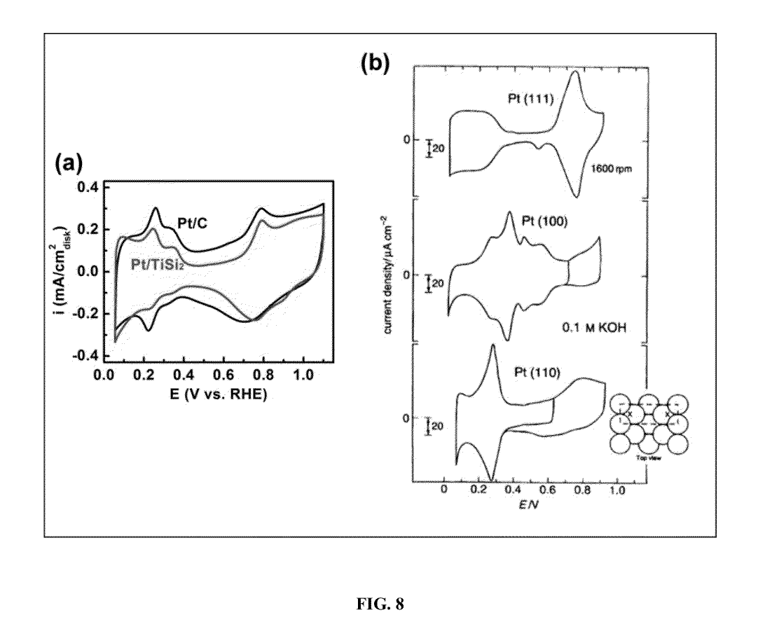

FIG. 8 shows certain exemplary data on effective surface area measurements. FIG. 8a shows CVs of Pt/TiSi₂ sample (red) and Pt/C sample (black) in 0.1 M KOH at 25° C., while FIG. 8b depicts CVs of Pt low-index single-crystal surfaces (Pt (111), Pt (100) and Pt (110)) in 0.1 M KOH. Adapted from Markovic et al., J. Chem. Soc., Faraday Trans., 1996. (Markovic, et al. 1996 J. Chem. Soc., Faraday Trans., 92, 3719-3725.)

ESA was determined from Pt—H adsorption/desorption region between 0.05-0.45 V vs. RHE. A surface charge density of 210 μC/cm² for a monolayer adsorption/desorption of hydrogen on Pt surface was employed for estimation. For similar sizes of Pt particles on TiSi₂ nanonets and Vulcan carbon, the calculated surface areas normalized to per gram of Pt were 35.1 m² g⁻¹ and 27.9 m² g⁻¹, respectively.

The CV of Pt/C sample in 0.1 M KOH has been reported by some of our previous papers. (Sheng, et al. 2010 J. Electrochem. Soc. 157, B1529-B1536.) Briefly, it showed the typical Pt—H underpotential deposition region, double-layer region, and Pt-oxide region. The Pt—H peaks at 0.2-0.3 V and 0.3-0.4 V can be attributed to the Pt—H interaction on Pt (110) and Pt (100) planes, respectively, based on the CVs of Pt single-crystal surfaces. However, the CV recorded on Pt/TiSi₂ showed a dramatically different pattern, with suppressed peaks from Pt—H interaction on Pt (110) and Pt (100) surfaces. Combining with the structure characterization data and the factor of low growth kinetics of ALD process, Pt on TiSi₂ has a higher Pt (111) surface concentration than Pt on C.

It has also been demonstrated that uniform and selective deposition of Ru NPs on TiSi₂ nanonets can be achieved by atomic layer deposition. The resulting materials (Ru/TiSi₂) showed promising performance in lithium oxygen batteries as an air cathode.

Ru deposition on TiSi₂ was found to be site selective (same as Pt ALD deposition on TiSi₂). The Ru nanoparticles were only grown on the top and bottom surfaces of a nanonet.

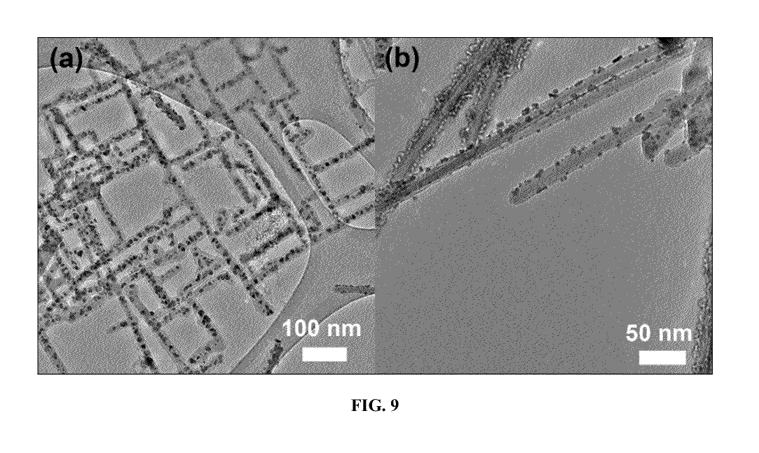

FIG. 9 shows exemplary microstructures of Ru/TiSi₂ heteronanostructures. FIG. 9a depicts view from the top, where a uniform distribution of Ru nanoparticles is observed. FIG. 9b depicts view from the side, where Ru nanoparticles are seen only on the top and bottom surfaces of TiSi₂.

Ru/TiSi₂ showed excellent performance as an air cathode in lithium oxygen batteries. The capacity reached 1000 mAh/g_{Ru} and good stability was demonstrated for 60 cycles.

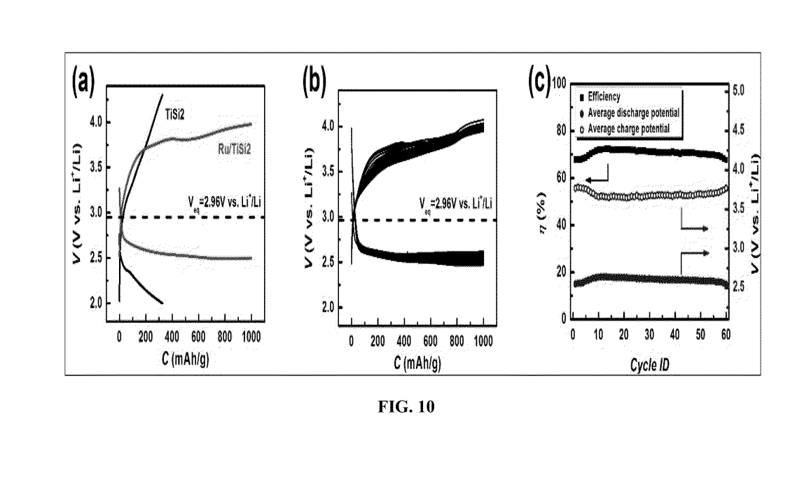

FIG. 10 shows cycle performance of Ru/TiSi₂ cathode. In FIG. 10a, Ru/TiSi₂ showed improved capacity and reduced overpotential compared to bare TiSi₂. As shown in FIG. 10b and FIG. 10c, Ru/TiSi₂ cycled for 60 cycles with limited performance drop.

Scanning electron microscope (SEM) characterization indicated a layer of Li₂O₂ product formed during discharge, which coated the entire Ru/TiSi₂ nanostructure. The Li₂O₂ product can be reversibly removed by charging the cathode, and the entire nanostructure remains integrity even after 60 repeated cycles.

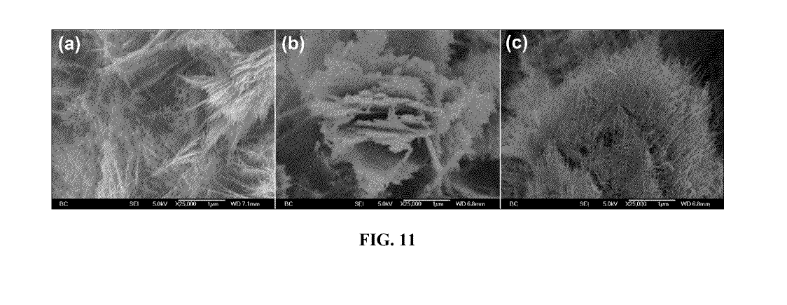

FIG. 11 shows structures of Ru/TiSi₂ before and after cycle test, wherein (a) as prepared Ru/TiSi₂; (b) Ru/TiSi₂ after 1^{st} discharge cycle; (c) Ru/TiSi₂ after 60 cycles, fully charged.

### EXPERIMENTAL

### TiSi₂ Nanonets Synthesis

TiSi₂ nanonets were synthesized by a chemical vapor deposition method. A Ti foil (Simga-Aldrich, 0.127 mm thick, purity: 99.7%) was placed in a home-built reaction chamber and heated to 675° C. Then, SiH₄ (10% in He, Voltaix; at 50 standard cubic centimeter per minute, or sccm), TiCl₄ (98%, Sigma-Aldrich; 2 sccm), and H₂ (Industrial grade, Airgas; 60 sccm) were introduced to the chamber, and the pressure was maintained constant at 5 Torr. The growth duration was typically 10-120 min for varying sizes and densities of nanonets.

### TiO₂-Coated TiSi₂ Nanonets

TiO₂ was deposited in a Cambridge nanotech (Savannah 100) ALD system following procedures we previously reported. (Lin, et al. 2009 J. Am. Chem. Soc. 131, 2772-2773.) In brief, the reaction took place at 275° C. with a constant flow of N₂ at 20 sccm. Titanium (IV) isopropoxide (Ti(ⁱPrO)₄, heated to 75° C.) and deionized H₂O (room temperature) were used as reaction precursors. The pulse and purge times for Ti(ⁱPrO)₄ and H₂O were 50 ms & 10 s, 15 ms & 10 s, respectively. A 10-cycle growth of TiO₂ (estimated thickness: 0.5 nm) was applied to the TiSi₂ nanonets to modify the surface.

### Si Nanowires

The preparation of Si NWs was reported previously. (Yuan, et al. 2011 Angew. Chem. Int. Ed. 50, 2334-2338.) Briefly, Si (100) substrate (Wafernet) was cleaned with acetone, methanol, and isopropanol sequentially. The substrate was then oxidized in H₂O₂/H₂SO₄ (1:3 vol:vol) solution at 90° C. for 10 min to remove heavy metals and organic residue, and then rinsed by deionized water. Finally, the cleaned substrate was immersed into an HF/AgNO₃ solution (4 M HF and 0.02 M AgNO₃) for 30 min at 50° C. to produce Si NWs.

### Atomic Layer Deposition of Pt

Pt nanoparticles were deposited in an Arradiance (Gemstar) atomic layer deposition system. The growth temperature was 250° C., with trimethyl-methylcyclopentadienyl platinum (IV) (MeCpPtMe₃, heated to 75° C.) and compressed air (room temperature) as reaction precursors. Each cycle consisted of four repeated pulse/purges of MeCpPtMe₃ for sufficient surface adsorption and one pulse/purge of O₂ to decompose MeCpPtMe₃. The purge gas was N₂, and its flow rate was 90 sccm.

In conducting Ru ALD, Ru nanoparticles were deposited on TiSi₂ nanonets in an Arradiance (Gemstar) atomic layer deposition system. The growth temperature was 290° C., with Bis(ethylcyclopentadienyl)ruthenium(II) (Ru(EtCp)₂, heated to 110° C.) and compressed air (room temperature) as reaction precursors. Each cycle consisted of four repeated pulse/purge sub-cycles of Ru(EtCp)₂ for sufficient surface adsorption and one pulse/purge of O₂ to decompose Ru(EtCp)₂. The purge gas was N₂, and its flow rate was 90 sccm.

### Material Characterizations

As-grown samples were imaged using a transmission electron microscope (TEM, JEOL 2010F) and a scanning electron microscope (SEM, JEOL 6340F). The TEM was operated at an acceleration voltage of 200 kV, and the SEM was at 10 kV. Elemental analysis was conducted using an energy dispersive spectroscopy (EDS) attachment to the TEM.

### Electrochemical Characterizations

Pt/TiSi₂ on flat Ti foil was attached onto the rotating disk electrode (glassy carbon electrode, 5 mm in diameter, Pine Instrument) for electrochemical measurements. The Pt/C electrode in the control experiment was prepared by first ultrasonicating the Pt/C nanoparticles (46 wt % supported by Vulcan carbon, Tanaka Kikinzoku (TKK), average diameter of Pt nanoparticles is 3.5 nm) in deionized water (Millipore, 18.2 MΩ) for 1 hour to make the ink, and then drop-casting the catalyst ink onto the same type of rotating disk electrode. The loading of nanoparticles was 50 μg_{Pt}/cm²_{disk}.

Measurement of effective surface area (ESA): Cyclic voltammetry (CV) were collected in 0.1 M KOH solutions at a temperature maintained at 25° C. A Pt wire sealed in glass tubing and an Ag/AgCl electrode (4 M KCl, Pine Instruments) were used as counter and reference electrode, respectively. The electrolyte was purged with N₂ (ultra high purity, Airgas) for 30 min before measurements. CVs were recorded at a scan rate of 50 mV s⁻¹ between 0.05 and 1.10 V vs. RHE until they were stabilized. CVs were then recorded and presented at a scan rate of 10 mV s⁻¹ in the same voltage range for ESA measurements.

Characterization of oxygen reduction activities: After ESA measurements, electrolyte was purged with O₂ (ultra high purity, Airgas) for 30 minutes before evaluating ORR activities of Pt/TiSi₂ and Pt/C samples. Polarization curves were recorded at various rotating rates (2500 rpm, 1600 rpm, 900 rpm, 400 rpm, 100 rpm) at a scan rate of 10 mV s⁻¹ between 0.05 and 1.10 V vs. RHE. To correct for capacitance contribution, oxygen reduction currents were obtained by subtracting the polarization curve in N₂ from the corresponding curve in O₂.

ORR Activities in this Study and among Literature Reports

The kinetic current density in this study was calculated by Koutecky-Levich equation

1/i=1/iₖ+i/i_{D} Equation (1)

where i is the measured current density, iₖ is the kinetic current density, and i_{D} is the diffusion limited current density. (Bard, A. J.; Faulkner, L. R., Electrochemical Methods: Fundamentals and Applications. 2000.) The specific activity or mass activity of Pt on carbon showed in FIG. 3d in the main text was determined to be 90 μA/cm²_{Pt} or 26.4 mA/mg_{Pt}. It is noted that it may not be fair to directly compare these values with the best reported ones in the literature as they are sensitive to measurement conditions (e.g., types of electrolyte, impurity, temperature, O₂ partial pressure, scan rates, etc.) and different types of Pt/C been measured (types of carbon, sizes/morphology of Pt NPs etc.), resulting in widely varying data from reports to reports. (Garsany, et al. 2010 Anal. Chem. 82, 6321-6328; Gasteiger, et al. 2005 Appl. Catal. B 56, 9-35.) For instance, it has been reported that the corrosion of glass flasks in the alkaline electrolyte may result in relatively low activities of the catalysts. (Mayrhofer, et al. 2008 J. Electrochem. Soc. 155, P1-P5.) Nonetheless, it is important to note that under identical test conditions, an improved performance by Pt/TiSi₂ as compared with commercial Pt/C is unambiguous.

In this specification and the appended claims, the singular forms “a,” “an,” and “the” include plural reference, unless the context clearly dictates otherwise.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

What is claimed is:

1. A catalytic system comprising nanoparticles of a metallic element grown onto one or more two-dimensional conductive nanostructures of TiSi₂, wherein the catalyst system does not comprise carbon.

2. The catalytic system of claim 1, wherein the metallic element is selected from Pt, Ru and Pd.

3. The catalytic system of claim 2, wherein the nanoparticles of a metallic element are grown onto the one or more two-dimensional conductive nanostructures of TiSi₂ by atomic layer deposition.

4. The catalytic system of claim 3, wherein the nanoparticles of a metallic element are grown onto the one or more two-dimensional conductive nanostructures of TiSi₂ without mask or patterning.

5. The catalytic system of claim 4, wherein the nanoparticles of a metallic element are selectively grown only on the top/bottom surfaces of the one or more two-dimensional conductive nanostructures of TiSi₂.

6. The catalytic system of claim 5, wherein the nanoparticles of a metallic element are crystalline.

7. The catalytic system of claim 4, wherein the nanostructures of TiSi₂ are nanonets of TiSi₂.

8. The catalytic system of claim 2, wherein the metallic element is Pt.

9. The catalytic system of claim 2, wherein the metallic element is Ru.

10. The catalytic system of claim 2, wherein the metallic element is Pd.

11. The catalytic system of claim 8, selectively exhibiting a 5-fold twinned structure exposing {111} surfaces of Pt.

12. A fuel cell comprising the catalytic system of claim 1.

13. A battery comprising the catalytic system of claim 1.

14. Nanoparticles of a metallic element grown on a surface of a two-dimensional conductive nanostructure of TiSi₂.

15. The nanoparticles of claim 14, wherein the metallic element is selected from Pt, Ru and Pd.

16. The nanoparticles of claim 15, wherein the two-dimensional conductive nanostructures of TiSi₂ are nanonets.

17. The nanoparticles of claim 16, selectively grown on one or more (020) planes of TiSi₂ nanonets.

18. The nanoparticles of claim 17, wherein the nanoparticles are crystalline.

19. The nanoparticles of claim 15, wherein the metallic element is Pt.

20. The nanoparticles of claim 15, wherein the metallic element is Ru.

21. The nanoparticles of claim 15, wherein the metallic element is Pd.

22. The nanoparticles of claim 19, selectively exhibiting a 5-fold twinned structure exposing {111} surfaces of Pt.

23. A catalytic system comprising the nanoparticles of claim 14.

24. A fuel cell comprising the catalytic system of claims 23.

25. A battery comprising the catalytic system of claims 23.

26. A method for growing a metallic element on a surface of substrate, comprising
providing one or more precursors of a metallic element;
providing TiSi₂ having one or more two-dimensional conductive nanostructures;
generating the metallic element in the gaseous phase; and
depositing the metallic element on the two-dimensional conductive nanostructures of TiSi₂,
wherein the metallic element exhibits a pre-select crystalline surface.

27. The method of claim 26, wherein the metallic element is selected from Pt, Ru and Pd.

28. The method of claim 26, wherein the one or more two-dimensional conductive nanostructures of TiSi₂ are nanonets.

29. The method of claim 26, wherein the metallic element selectively grows on one or more (020) planes of TiSi₂ nanonets.

30. The method of claim 26, wherein the metallic element is Pt.

31. The method of claim 26, wherein the metallic element is Ru.

32. The method of claim 26, wherein the metallic element is Pd.

33. The method of claim 30, selectively exhibiting a 5-fold twinned structure exposing {111} surfaces of Pt.

34. Nanoparticles of a metallic element grown according to the method of claim 26.
